(19) United States
(12) Patent Application Publication
(10) Pub. No.: US 2021/0261808 A1
(43) Pub. Date: Aug. 26, 2021

(54) AQUEOUS FLUORORESIN COATING COMPOSITION

(71) Applicants: THE CHEMOURS COMPANY FC, LLC, WILMINGTON, DE (US); CHEMOURS-MITSUI FLUOROPRODUCTS CO., LTD, TOKYO (JP)

(72) Inventor: YUQING LIU, SHIZUOKA (JP)

(73) Assignees: THE CHEMOURS COMPANY FC, LLC, WILMINGTON, DE (US); CHEMOURS-MITSUI FLUOROPRODUCTS CO. LTD., TOKYO (JP)

(21) Appl. No.: 17/253,244

(22) PCT Filed: Jun. 17, 2019
(86) PCT No.: PCT/US2019/037440

§ 371 Date: Dec. 17, 2020

(30) Foreign Application Priority Data
Jun. 20, 2018 (JP) 2018-117204

(51) Int. Cl. C09D 127/18; A47J 36/02

(52) U.S. Cl. CPC C09D 127/18; A47J 36/025

(57) ABSTRACT

Provided are aqueous fluororesin coating compositions including a water-soluble polyamideimide resin, a polyetherimide, and a fluororesin. Also provided are coatings on substrates formed from the coating composition and coated substrates, the coatings being strongly adhered to the substrates and having excellent water vapor and corrosion resistance. The coatings are of utility for metal substrates, for example cookware such as a frying pans and rice cookers.

### CROSS-REFERENCE TO RELATED APPLICATIONS

This application claims the benefit of Japanese Patent Application No. JP 2018-117204, filed Jun. 20, 2018, which is incorporated by reference herein in its entirety.

### TECHNICAL FIELD

The present invention relates to aqueous fluororesin coating compositions, coatings formed from the coating compositions that strongly adhere to substrates and have excellent water vapor and corrosion resistance, and articles comprising the coatings.

### BACKGROUND

Fluororesins have excellent heat resistance, chemical resistance, electrical properties, and mechanical properties, and have an extremely low coefficient of friction, non-tackiness, and water and oil repellency, and therefore are widely used in many industrial fields such as chemical, machinery, and electronics.

Particularly, utilizing the non-tackiness, water and oil repellency of fluororesins, fluororesin coatings are used in various fields including coating of cookware such as a frying pans and rice cookers; fixing rolls/belts for fixing toner of OA (office automation) equipment; and the like. In recent years, fields of their applications have been further expanded to inkjet printer nozzles, chemical plant equipment, and the like.

When a fluororesin is coated onto various substrates, however, it is extremely difficult to coat a fluororesin directly onto a substrate because of adhesive failure due to the non-tackiness and lack of adhesion to the substrate, a property of a fluororesin. Thus, when a fluororesin is coated on a substrate, a primer coating composition having adhesion to the substrate and also to the fluororesin is usually coated on the substrate before the fluororesin.

For such a primer coating composition, a heat resistant resin (a so-called engineering plastic) that has adhesion to the given substrate and can resist elevated temperatures higher than the melting point of the fluororesin is used. For example, Patent Document 1 discloses precursors of a polyimide, a polyamideimide, a polyethersulfone, and the like, and a particulate of a polyphenylenesulfide as primers. Such a heat resistant resin is also often referred to as a binder.

On the other hand, as the medium for carrying and delivering a fluororesin coating composition including a primer coating composition, an organic solvent (a solvent-based coating) or water (an aqueous coating) is used. From the viewpoint of environmental loads and harmful effects to humans, particularly in recent years, an aqueous (water-based) coating composition is preferably used. In some aqueous coating compositions, because the heat resistant resin (binder) to impart adhesion to a substrate is water-insoluble and particles thereof must be dispersed in the liquid of the coating composition for use, instead, a water-soluble polyamideimide can be also used (Patent Document 2).

If a water-soluble polyamideimide (water-soluble PAI) is used as a heat resistant resin (binder), it is uniformly dissolved in the aqueous fluororesin coating composition, and thus a high adhesion strength is obtained even in a small amount. Therefore, the content of the fluororesin can be increased, enabling the aqueous coating composition to be used not only as a primer coating but also as a one-coat coating that can exhibit the effect with only one layer without a primer.

In addition, because of a high viscosity of a water-soluble polyamideimide, use of a thickener can be reduced or avoided, thereby increasing purity of the coating, and thus a better performance can be obtained. Furthermore, the use of a water-soluble polyamideimide eliminates the need for a dispersion process and a control of a dispersion degree, which are required when powder of typical various engineering plastics is used as a heat resistant resin (binder), and thus also has advantages of being excellent in productivity and facilitating quality control.

Therefore, it is desired that a water-soluble polyamideimide be used as a heat resistant resin (binder) to impart adhesion with a substrate in an aqueous coating composition.

Coatings obtained from fluororesin compositions using conventional water-soluble polyamideimides, however, are insufficient in water vapor resistance and corrosion resistance, thereby making them undesirable in cookware applications such as a frying pan and a rice cooker, requiring these properties.

Accordingly, as aqueous coating compositions excellent in water vapor resistance and corrosion resistance, fluororesin coating compositions using a polyethersulfone resin together with a water-soluble polyamideimide have been hitherto proposed (Patent Document 3). As described later, however, according to comparative examples tested by the present inventors, it cannot be said that coating compositions using a polyethersulfone resin together with a water-soluble polyamideimide are sufficient in corrosion resistance to be applied to cookware.

In addition, Patent Document 4 proposes a fluororesin coating composition wherein water vapor resistance of a coating to be formed is improved by using a water-soluble polyamideimide comprising, as a structural unit, 3,3′-dimethylbiphenyl-4,4′-diisocyanate and/or 3,3′-dimethylbiphenyl-4,4′-diamine. Again, in this fluororesin coating composition, however, water vapor resistance and corrosion resistance sufficient for applications in cookware have not been obtained.

Furthermore, although N-methyl-2-pyrrolidone (NMP) has been conventionally often used as a solvent for dissolution, dilution, and synthesis for a water-soluble polyamideimide resin, toxicities (particularly reproductive toxicity) of NMP are perceived as problems in recent years, and a fluororesin coating composition including a water-soluble polyamideimide resin using low toxic N-formylmorpholine as a solvent instead of NMP is also proposed (Patent Document 5). Also in this fluororesin coating composition, however, problems of water vapor resistance and corrosion resistance for applications in cookware are not solved.

### CITATION LIST

### Patent Document

Patent Document 1: JP H04-071951 B2
Patent Document 2: JP 3491624 B2
Patent Document 3: JP 4534916 B2
Patent Document 4: WO 2016/175099 A1
Patent Document 5: JP 2016-089016 A

### SUMMARY OF INVENTION

### Technical Problem

An object of the present invention is to provide an aqueous fluororesin coating composition that strongly adheres to substrates, and combines high levels of (excellent) water vapor resistance and corrosion resistance, and is suitable for use as cookware such as a frying pans and rice cookers, and is also excellent in environmental, safety and hygiene aspects.

### Solution to Problem

In order to achieve the above object, according to the present invention disclosed herein is an aqueous fluororesin coating composition comprising water-soluble polyamideimide resin, polyetherimide, and fluororesin.

The aqueous fluororesin coating composition of the present invention has a number of embodiments, including.
1. An aqueous fluororesin coating composition comprising a water-soluble polyamideimide resin, a polyetherimide, and a fluororesin.
2. The aqueous fluororesin coating composition according to 1., wherein the amount of the fluororesin is from 35 to 90 mass % with respect to the total mass of the water-soluble polyamideimide resin, the polyetherimide, and the fluororesin.
3. The aqueous fluororesin coating composition according to 1. or 2., wherein the fluororesin is a melt-flowable perfluoro resin.
4. The aqueous fluororesin coating composition according to any of 1. to 3., wherein the fluororesin is a tetrafluoroethylene-perfluoro(alkylvinylether) copolymer.
5. A coating formed by coating the aqueous fluororesin coating composition described in any of 1. to 4.
6. A coated article including the coating described in 5.
7. The coated article according to 6., wherein the coated article is cookware.

### Advantageous Effects of Invention

According to the present invention, there is provided an aqueous fluororesin coating composition of utility for forming coatings having excellent adhesion to substrates, and high levels of water vapor resistance and corrosion resistance, for example resulting in the coatings having utility in cookware. In addition, according to the present invention, there is provided an aqueous fluororesin coating composition also excellent in environmental, safety and hygiene aspects.

Furthermore, according to the present invention, a coating with a high fluororesin content is provided, and performance of the fluororesin coating is improved.

### BRIEF DESCRIPTION OF DRAWINGS

FIG. 1 is a schematic view illustrating a procedure for preparing a test piece for evaluating adhesion to a substrate.

### DESCRIPTION OF EMBODIMENTS

The present invention will be described in detail below.

### 1. Aqueous Fluororesin Coating Composition

An “aqueous fluororesin coating composition” of the present invention includes a water-soluble polyamideimide resin, a polyetherimide, and a fluororesin.

### Aqueous Fluororesin Coating Composition

An “aqueous fluororesin coating composition” of the present invention is an aqueous (water-based) dispersion of a water-soluble polyamideimide resin, a polyetherimide, and a fluororesin. The fluororesin coating composition of the present invention is in general suitably used as a primer coating (undercoating) to adhere a fluororesin layer to a substrate, but it can be also used as a one-coat coating that does not use a primer coating.

### Water-Soluble Polyamideimide Resin (PAI)

A “water-soluble polyamideimide resin (water-soluble PAI)” used in the present invention is a water-soluble resin having an amide bond and an imide bond in a main chain, and preferably those having a repeating unit represented by the following general Formula 1:

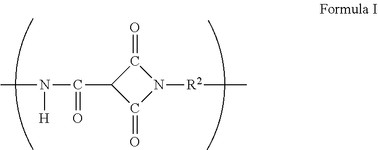

wherein, R¹ represents a trivalent organic group; and R² represents a divalent organic group.

In one embodiment the water-soluble PAI used in the present invention is obtained by copolymerizing a diisocyanate compound or a diamine compound as an amine component and a tribasic acid anhydride or a tribasic acid halide as an acid component in a polar solvent. Synthesis conditions of the water-soluble PAI vary and are not particularly limited, but in general the synthesis is performed at a temperature from 80 to 180° C., and in order to reduce the influence of moisture in the air, it is preferably performed under a nitrogen atmosphere.

The diisocyanate compound is not particularly limited, but examples thereof include a diisocyanate compound represented by the following formula: OCN—X—NCO, wherein X represents a divalent organic group. Examples of the divalent organic group represented by X include: an alkylene group having from 1 to 20 carbons; an arylene group, such as a phenylene group and a naphtylene group, unsubstituted or substituted with a lower alkyl group having from 1 to 5 carbons such as a methyl group or a lower alkoxy group having from 1 to 5 carbons such as a methoxy group; a divalent organic group formed by two arylene groups described above bound via a single bond, a lower alkylene group having from 1 to 5 carbons, an oxy group (—O—), a carbonyl group (—CO—), or a sulfonyl group (—SO₂—); a divalent organic group formed by two lower alkylene groups, having from 1 to 5 carbons, the two lower alkylene groups being bound via the arylene group described above; and the like. The alkylene group has preferably from 1 to 18 carbons, more preferably from 1 to 12 carbons, still more preferably from 1 to 6 carbons, and particularly preferably from 1 to 4 carbons.

The divalent organic group represented by X is, from the viewpoint of reactivity, an improvement of adhesion strength of the coating, and the like, preferably a divalent organic group formed by two arylene groups described above bound via a single bond, a lower alkylene group having from 1 to 5 carbons, an oxy group (—O—), a carbonyl group (—CO—), or a sulfonyl group (—SO₂—); more preferably a divalent organic group formed by two arylene groups described above bound via a single bond or a lower alkylene group having from 1 to 5 carbons; and still more preferably a divalent organic group formed by two phenylene groups bound via a single bond or a lower alkylene group having from 1 to 5 carbons. Also if two or more types of diisocyanate compounds are used in combination, the two or more types are preferably selected for use from these preferred aspects. In addition, from the viewpoint of reactivity, the arylene group is preferably unsubstituted, and from the viewpoint of an improvement of adhesion strength of the coating, it is preferably substituted with a lower alkyl group having from 1 to 5 carbons such as a methyl group or a lower alkoxy group having from 1 to 5 carbons such as a methoxy group.

Examples of the diisocyanate compound specifically include xylylene diisocyanate, para-phenylene diisocyanate, tolylene diisocyanate, naphthalene diisocyanate, 3,3′-diphenylmethane diisocyanate, 4,4′-diphenylmethane diisocyanate, 3,3′-dimethylbiphenyl-4,4′-diisocyanate, 3,3′-dimethoxybiphenyl-4,4′-diisocyanate, hexamethylene diisocyanate, isophorone diisocyanate, and the like.

The diamine compound is not particularly limited, but examples thereof include a compound wherein the isocyanate groups are replaced with amine groups in the diisocyanate compound formula OCN—X—NCO. Examples of the diamine compounds specifically include xylylene diamine, phenylene diamine, 4,4′-diaminodiphenylmethane, 4,4′-diaminodiphenylether, 4,4′-diaminodiphenylsulfone, 3,3′-diaminodiphenylsulfone, 3,3′-dimethylbiphenyl-4,4′-diamine, isophorone diamine, and the like.

As the amine component (the diisocyanate compound, the diamine compound), using 3,3′-dimethylbiphenyl-4,4′-diisocyanate and/or 3,3′-dimethylbiphenyl-4,4′-diamine is preferred because adhesion strength to a substrate and water vapor resistance of the coating can be improved. In addition, from the viewpoint of improving the work environment, using 3,3′-dimethylbiphenyl-4,4′-diisocyanate is preferred (Patent Document 4).

For the reaction, the diisocyanate compound may be used alone, the diamine compound may be used alone, or the diisocyanate compound and the diamine compound may be used in combination. From the viewpoint of facilitating the reaction, the diisocyanate compound is preferably used.

Examples of the tribasic acid anhydride include a tricarboxylic anhydride. The tribasic acid anhydride is not particularly limited, but preferably an aromatic tribasic acid anhydride, more preferably an aromatic tricarboxylic anhydride, and still more preferably a compound represented by the following Formula (2) or Formula (3). From the viewpoint of heat resistance, cost, and the like, trimellitic anhydride is particularly preferred.

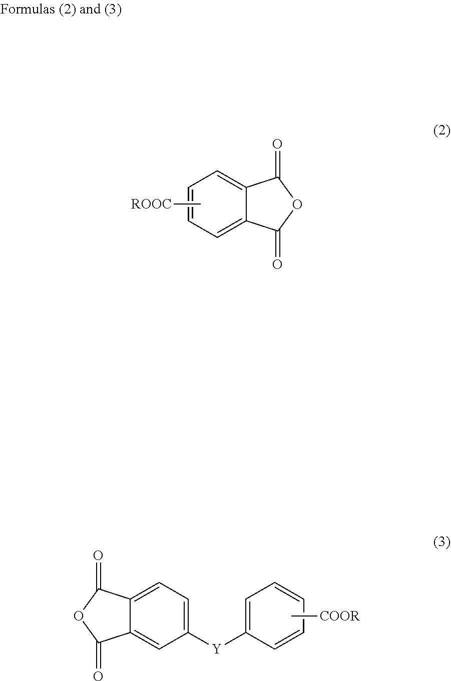

wherein R represents a hydrogen atom, an alkyl group having from 1 to 10 carbons, or a phenyl group; and Y represents —CH₂—, —CO—, —SO₂—, or —O—.

As the tribasic acid halide, tribasic acid anhydride halides are preferably used, and examples thereof include tricarboxylic anhydride halides. The tribasic acid anhydride halide is preferably a tribasic acid anhydride chloride. The tribasic acid anhydride chloride is not particularly limited, but preferably an aromatic tribasic acid anhydride chloride, more preferably an aromatic tricarboxylic anhydride chloride, and still more preferably a compound wherein the —COOR group is replaced with a —COCl group in Formula (2) or Formula (3) described above. From the viewpoint of heat resistance, cost, and the like, trimellitic anhydride chloride (anhydrous trimellitic acid chloride) is particularly preferred.

From the viewpoint of reducing environmental loads, a tricarboxylic anhydride is preferably used, and trimellitic anhydride is particularly preferred.

As the acid component, in addition to the tribasic acid anhydride and the tribasic acid halide, in order to improve hydrophilicity, a polybasic acid or a polybasic acid anhydride, such as a dicarboxylic acid and a tetracarboxylic dianhydride, can be used as long as it does not impair properties of the PAI such as heat resistance.

The dicarboxylic acid is not particularly limited, but examples thereof include terephthalic acid, isophthalic acid, adipic acid, sebacic acid, and the like. The tetracarboxylic dianhydride is not particularly limited, but examples thereof include pyromellitic dianhydride, benzophenone tetracarboxylic dianhydride, biphenyl tetracarboxylic dianhydride, and the like. Only one type of the polybasic acid and the polybasic acid anhydride each may be used, or two or more types thereof may be used in combination.

A usage amount of the polybasic acid and the polybasic acid anhydride other than the tribasic acid anhydride and the tribasic acid halide (for example, dicarboxylic acid, tetracarboxylic dianhydride) is, from the viewpoint of maintaining properties of the PAI such as heat resistance, preferably from 0 to 50 mol %, more preferably from 0 to 30 mol %, and still more preferably from 0 to 15 mol %, in all the acid components.

With regard to a usage ratio of the diisocyanate compound and/or the diamine compound and the acid component (the tribasic acid anhydride and/or tribasic acid halide, as well as the dicarboxylic acid and/or the tetracarboxylic dianhydride and the like used as necessary), from the viewpoint of a molecular weight and a degree of cross-linking of the PAI to be formed, a total amount of the diisocyanate compound and/or the diamine compound is from 0.8 to 1.1 mol, preferably from 0.95 to 1.08 mole, and more preferably from 1.0 to 1.08 mol, with respect to the total amount of the acid components of 1.0 mol.

As the PAI, a PAI obtained by reacting the diisocyanate compound and/or the diamine compound, and the acid component can be used as it is. It can be also used after protecting with a blocking agent.

When the diisocyanate compound is used as a raw material compound, in order to stabilize the PAI, a blocking agent for the terminal isocyanate group (terminal blocking agent) may be optionally used. Protecting with a blocking agent results in a PAI having no isocyanate group (—NCO group) or having a reduced amount of the isocyanate group (—NCO group) as compared with a PAI obtained by reacting the isocyanate compound and the acid component.

Examples of the blocking agent include alcohols, and examples of the alcohols include lower alcohols having from 1 to 6 carbons such as methanol, ethanol, and propanol. Examples of the blocking agent also include 2-butanoneoxime, δ-valerolactam, ε-caprolactam, and the like. The blocking agent is not limited to these exemplified compounds. One type of the blocking agent alone or two or more types thereof in combination may be used.

As the polar solvent, N-methyl-2-pyrrolidone (NMP), N-ethylmorpholine, N-formylmorpholine, N-acetylmorpholine, N,N′-dimethylethyleneurea, N,N-dimethylacetoamide, or N,N-dimethylformamide, γ-butyrolactone, and the like can be used. NMP has been preferably used thus far because it is readily available and has a high boiling point, but from the viewpoint of influences on human health, regulations such as the REACH Regulation, the US FDA, and the like, N-ethylmorpholine and N-formylmorpholine are preferably used.

The amount of solvent used is not particularly limited, but from 50 to 500 parts by mass per 100 parts by mass of a total amount of the amine component and the acid component is preferred from the viewpoint of the solubility of the resulting resin.

In one embodiment, the number average molecular weight of the PAI is, from the viewpoint of ensuring the strength of the coating, not less than 5,000, preferably not less than 10,000, more preferably not less than 13,000, and particularly preferably not less than 15,000. In another embodiment, the number average molecular weight is, from the viewpoint of ensuring the solubility in water, not greater than 50,000, preferably not greater than 30,000, more preferably not greater than 25,000, and particularly preferably not greater than 20,000.

The number average molecular weight of the PAI can be controlled by sampling the PAI during its synthesis to measure the number average molecular weight, and continuing the synthesis until the targeted number average molecular weight is obtained. The number average molecular weight can be measured by gel permeation chromatography (GPC) using a calibration curve of standard polystyrenes.

In one embodiment, the PAI has an acid value of not less than 10 mg KOH/g when the carboxyl groups and carboxyl groups formed by ring-opening of the acid anhydrides in the resin are combined. It is preferably not less than 25 mg KOH/g and more preferably not less than 35 mg KOH/g. These ranges are preferred ranges from the viewpoint of facilitating the dissolution or the dispersion of the PAI. In addition, when a basic compound described later is contained, they are preferred ranges also because the amount of the carboxyl group to react with the basic compound becomes sufficient and water-solubilization is facilitated.

Furthermore, the acid value is, from the viewpoint of preventing the fluororesin coating composition to be finally obtained from gelating with the lapse of days, not greater than 80 mg KOH/g. It is preferably not greater than 60 mg KOH/g, and further not greater than 50 mg KOH/g.

The acid value can be obtained by the following method. First, 0.5 g of the PAI is sampled, 0.15 g of 1,4-diazabicyclo[2,2,2]octane is added thereto, 60 g of N-methyl-2-pyrrolidone and 1 mL of ion-exchanged water are further added and stirred until the PAI is completely dissolved to prepare a solution for evaluation. The solution for evaluation is titrated by potentiometric titration with a 0.05 mol/L potassium hydroxide ethanol solution to obtain the acid value. The acid value is an acid value obtained by combining the carboxyl groups and carboxyl groups formed by ring-opening of the acid anhydrides in the resin.

In one embodiment, in order to increase the solubility of the PAI in water, a basic compound may be combined with the PAI and water mixture. The basic compound reacts with the carboxyl group contained in the PAI to form a salt of the basic compound and the PAI. By the action of the basic compound, the solubility of the PAI in water can be increased.

In the present invention, examples of the basic compound include: alkylamines such as triethylamine, tributylamine, N,N-dimethylcyclohexylamine, N,N-dimethylbenzylamine, triethylenediamine, N-methylmorpholine, N,N,N′,N′-tetramethylethylenediamine, N,N,N′,N″,N″-pentamethyldiethylenetriamine, N,N′,N′-trimethylaminoethylpiperazine, diethylamine, diisopropylamine, dibutylamine, ethylamine, isopropylamine, and butylamine; alkanolamines such as monoethanolamine, diethanolamine, triethanolamine, dipropanolamine, tripropanolamine, N-ethylethanolamine, N,N-dimethylethanolamine, N,N-diethylethanolamine, cyclohexanolamine, N-methylcyclohexanolamine, and N-benzylethanolamine; caustic alkalis such as sodium hydroxide and potassium hydroxide; or ammonia and the like. From the viewpoint of increasing the solubility of the PAI in water, alkylamines and/or alkanolamines are suitable.

In one embodiment, the basic compound is, from the viewpoint of facilitating water-solubilization of the PAI and improving the strength of the coating, used in an amount not less than 2.5 equivalent, preferably not less than 3.5 equivalent, and more preferably not less than 4 equivalent, with respect to carboxyl groups and ring-opened acid anhydrides contained in the resin. In one embodiment, the content of the basic compound is, from the viewpoint of maintaining the strength, used in an amount not greater than 10 equivalent, preferably not greater than 8 equivalent, and more preferably not greater than 6 equivalent.

Specific water-soluble PAIS and manufacturing methods therefor are described in Patent Document 3, Patent Document 4, Patent Document 5, JP 2016-017084 A, JP 2018-002802 A, and the like.

The water-soluble PAI used in the present invention is generally used as a solution in order to prepare the fluororesin coating composition. The water-soluble PAI solution can be readily obtained by dissolving a water-soluble PAI in water containing an organic solvent.

The organic solvents described above are not particularly limited as long as they have high polarity and high boiling points, and various polar solvents that can be used for the polymerization of PAIS are available. Similarly to the solvent used for the polymerization, NMP has been preferably used thus far because it is readily available and has a high boiling point, but from the viewpoint of influences on human health, regulations such as the REACH Regulation, the US FDA, and the like, N-ethylmorpholine and N-formylmorpholine are preferably used.

The organic solvent described above may be the same solvent that can be contained in an aqueous medium described later in the fluororesin coating composition of the present invention.

In one embodiment, in view of viscosity, the content of PAI in the water-soluble PAI solution is from 1 to 50 mass %, and preferably from 5 to 40 mass %.

Examples of commercially available products of such water-soluble PAI solutions include HPC-1000-28 and HPC-2100D-28 manufactured by Hitachi Chemical Co., Ltd., and preferably HPC-2100D-28.

### Polyetherimide (PEI)

The “polyetherimide (PEI)” used in the present invention is not particularly limited as long as it is a noncrystalline polymer having imide bonds and ether bonds in the main chain. In one embodiment the condensation polymerization product of 2,2-bis[4-(3,4-dicarboxyphenoxy)phenyl]propane and m-phenylenediamine is preferred.

An example of a commercially available product of the PEI used in the present invention includes Ultem 1000F3SP-1000 manufactured by SABIC.

In one embodiment, the PEI is, in the fluororesin coating composition of the present invention, 30 to 90 mass % and preferably 50 to 75 mass % of a total mass of the water-soluble PAI and the PEI. If it is less than 30 mass %, corrosion resistance and water vapor resistance of the resulting coating is decreased, and if it is greater than 90 mass %, heat resistance of the coating is deteriorated and the hardness of the coating is also decreased.

The PEI is, in the fluororesin coating composition of the present invention, dispersed as particles in an aqueous medium described later, or dissolved in the aqueous medium. In one embodiment, when the PEI is dispersed as particles in the aqueous medium, the particles are preferably particles having an average particle diameter from 0.1 to 20 μm. If the average particle diameter of the PEI is within the range described above, corrosion resistance of the coating obtained from the fluororesin coating composition of the present invention is good. The average particle diameter described above is a value (D50) obtained by measuring by the centrifugal sedimentation method. In addition, a maximum particle diameter (Dmax) obtained by measuring by centrifugal sedimentation method is preferably less than 75 μm.

### Fluororesin

Examples of the “fluororesin” used in the present invention include polytetrafluoroethylenes (PTFE), tetrafluoroethylene-perfluoro (alkylvinylether) copolymers (PFA), tetrafluoroethylene-hexafluoropropylene copolymers (FEP), tetrafluoroethylene-hexafluoropropylene-perfluoro (alkylvinylether) copolymers, tetrafluoroethylene-ethylene copolymers, polyvinylidene fluorides, polychlorotrifluoroethylenes, chlorotrifluoroethylene-ethylene copolymers, and the like, and they can be manufactured by a conventionally well-known method such as solution polymerization, emulsion polymerization, and suspension polymerization.

As the fluororesin used for the aqueous fluororesin coating composition of the present invention, a perfluororesin wherein all hydrogen atoms in the molecular chain are replaced with fluorine, such as PTFE, PFA, FEP, a tetrafluoroethylene-hexafluoropropylene-perfluoro (alkylvinylether) copolymer, is preferably used from the viewpoint of non-tackiness and heat resistance of the coating. Here, although a high molecular weight PTEE exhibiting no melt flowability at a melting point or greater can be also used, it is preferred that a melt-flowable fluororesin exhibiting melt flowability at its melting point or greater be used. This is because generation of pinholes can be suppressed when the coating is formed, and a uniform and smooth coating is obtained. Among them, PFA is a particularly preferred perfluororesin because it has excellent heat resistance.

In one embodiment, when PFA is used, the alkyl group of the perfluoro (alkylvinylether) in the PFA has from 1 to 5 carbons, and preferably has from 1 to 3 carbons. Further, in one embodiment it is preferred that an amount of perfluoro (alkylvinylether) in the PFA be in the range from 1 to 50 mass %.

In the aqueous fluororesin coating composition of the present invention, it is preferred that PTFE exhibiting no melt flowability even at a temperature exceeding its melting point be used along with a melt-flowable fluororesin such as PFA. Stress remaining in the coating after heating can thereby be reduced and the cost can also be reduced.

The fluororesin of the present invention can be used by dispersing powder obtained by separating and drying a resin obtained by a well-known polymerization method, powder obtained by further milling the above powder, or powder finely granulated according to a method described in JP 52-044576 B and the like, in a coating composition. In addition, a fluororesin dispersion liquid (dispersion) polymerized by emulsion polymerization can be used as obtained from the polymerization. Those obtained by adding a surfactant to a fluororesin dispersion liquid to stabilize and those obtained by adjusting a concentration of the fluororesin to be high by concentration according to a well-known technique such as a method described in U.S. Pat. No. 3,037,953 can be also used. The stabilized fluororesin dispersion liquid is preferred because the fluororesin does not aggregate or sediment and the dispersion state can be maintained over a long period of time.

In one embodiment, the concentration of the fluororesin dispersion liquid used in the coating composition of the present invention is from 20 to 70 mass %. In another embodiment, those fluororesin dispersions concentrated to 40 to 70 mass % is preferably used because it facilitates adjustment of the fluororesin concentration in the coating composition. Commercially available fluororesin dispersion liquid products used in the present invention are exemplified by TEFLON (Registered Trademark) PTFE 31-JR, PTFE 34-JR, and PFA 334-JR manufactured by DuPont-Mitsui Fluorochemicals Company, Ltd.

In one embodiment, when the fluororesin coating composition of the present invention is used as a primer coating, the fluororesin is from 35 to 90 mass % and preferably 45 to 80 mass % with respect to the total of the water-soluble PAI, the PEI, and the fluororesin. If the fluororesin is less than 35 mass %, water vapor resistance and corrosion resistance of the coating is reduced, and adhesion of the top coat is reduced, and on the other hand if the fluororesin is greater than 90 mass %, corrosion resistance of the coating is reduced, and adhesion to a substrate and strength of the coating is reduced.

In one embodiment, when the fluororesin coating composition of the present invention is used as a one-coat coating, the fluororesin is from 5 to 90 mass % and preferably 10 to 70 mass % with respect to the total of the resin solids content. If the fluororesin is less than 5 mass %, water vapor resistance and corrosion resistance of the coating is reduced, and properties of the fluororesin coating such as releasability are not sufficiently obtained. On the other hand, if the fluororesin is greater than 90 mass %, similarly to the primer coating, corrosion resistance of the coating is reduced, and adhesion to a substrate and strength of the coating are reduced.

In the present invention, the “resin solid content” described above means the total mass of binder resins (i.e., the water-soluble PAI, the PEI, and other heat resistant resins) and the fluororesin in a residue after the fluororesin coating composition of the present invention is coated onto a coated object, then dried at a temperature within a range of about 80 to 100° C. and then sintered at about 380° C. for 45 minutes.

In the fluororesin coating composition of the present invention, the fluororesin is dispersed as particles in an aqueous medium. In one embodiment, the fluororesin described above is composed of particles having an average particle diameter from 0.01 to 50 μm. If the average particle diameter is less than 0.01 μm, the dispersibility of the particles is poor, and the resulting coating composition is inferior in mechanical stability and storage stability. If the average particle diameter is greater than 50 μm, uniform dispersibility of the particles is insufficient, and when the resulting coating composition is used to coat, a coating with a smooth surface cannot be obtained, and physical properties of the coating may be inferior. A more preferred upper limit is 5 μm, a still more preferred upper limit is 0.5 μm, and a more preferred lower limit is 0.05 μm. The mechanical stability described above means a property of hardly forming aggregates that cannot be re-dispersed even if strong stirring and a shear force are imposed with a homogenizer and the like during liquid feeding and redispersion.

### Other Components

In one embodiment, various fillers used in general coatings can be also added to the fluororesin coating composition of the present invention depending on desired properties, such as dispersibility, conductivity, foam prevention, and improved wear resistance. Examples thereof include surfactants (for example, polyoxyethylene alkyl ether-, polyoxyethylene alkyl phenyl ether-type nonionic surfactants such as LEOCOL manufactured by Lion Corporation, the TRITON and TERGITOL series manufactured by The Dow Chemical Company, and EMULGEN manufactured by Kao Corporation; sulfosuccinate salts such as REPEARL manufactured by Lion Corporation, EMAL and PELEX manufactured by Kao Corporation; sodium salts of alkyl ether sulfonic acids; mono long chain alkyl sulfate-based anionic surfactants; polycarboxylate salts such as LEOAL manufactured by Lion Corporation, OROTAN manufactured by The Dow Chemical Company; acrylate salt-based polymeric surfactants; L-77 manufactured by Momentive Performance Materials Inc.; the SURFINOL series manufactured by Air Products and Chemicals, Inc. (SURFINOL 420, SURFINOL 440, SURFINOL 465, SURFINOL 485, and the like)), film forming agents (for example, polymeric film forming agents such as polyamides, polyamideimides, acrylics, acetates; higher alcohols and ethers; polymeric surfactants having a film forming effect), and thickeners (e.g., water-soluble celluloses, solvent dispersion thickeners, sodium alginates, caseins, sodium caseinate, xanthan gum, polyacrylic acid, acrylic esters).

In one embodiment, various organic substances and inorganic substances can be added as binders and fillers to the fluororesin coating composition of the present invention, depending on the desired properties. Examples of the organic substances include engineering plastics, such as polyphenylenesulfide, polyetheretherketones, polyethersulfone, polyphenylsulfone, polyamide, polyimide, phenol resins, urea resins, epoxy resins, urethane resins, melamine resins, polyester resins, polyether resins, acrylic resins, acrylic silicone resins, silicone resins, silicone polyester resins. Examples of the inorganic substances include metal powder, metal oxides (e.g., aluminum oxide, zinc oxide, tin oxide, titanium oxide, and the like), glass, ceramics, silicon carbide, silicon oxide, calcium fluoride, carbon black, graphite, mica, barium sulfate, and the like. With regard to the shape of the filler, substances having various shapes, such as particle shape, fiber shape, and flake shape, can be used.

### Aqueous Medium

The aqueous fluororesin coating composition of the present invention includes water as the main medium. In one embodiment, although not preferred from consideration of environmental and cost aspects, a polar solvent compatible with water can be added to the aqueous fluororesin coating composition, and/or an organic solvent incompatible with water can be dispersed in the aqueous fluororesin coating composition. Such cosolvents can be included in such embodiments for the proper adjustment of rheological properties, such as liquid viscosity of the aqueous fluororesin coating composition, and improved dispersibility of the PEI, the fillers, and the like. In addition, by adding a polar solvent and thereby dissolving a heat resistant resin (binder), the following effects are expected: the heat resistant resin (binder) becomes more uniform in the drying and thermal curing process after coating, thereby densifying the coating; and the heat resistant resin (binder) easily enters a concave portion of the uneven surface of a substrate, thereby improving adhesion strength with the substrate.

### Manufacturing Process of Fluororesin Coating Composition

The fluororesin coating composition of the present invention can be prepared by conventionally well-known methods and the like. For example, obtained by mixing as appropriate the water-soluble PAI solution described above in which the water-soluble PAI is dissolved in water containing an organic solvent, the PEI, the fluororesin, and other additives and fillers to be compounded as necessary. In one embodiment of the fluororesin coating composition of the present invention, the PEI, the fluororesin, a pigment may be prepared in advance in each dispersion (dispersion liquid) so that the resulting dispersions may be mixed to prepare the fluororesin coating composition.

In one embodiment the fluororesin coating composition of the present invention has a viscosity from 0.1 to 50,000 mPa·s at 25° C. If the viscosity is less than 0.1 mPa·s, the composition may easily cause dripping and the like during coating onto the coated object, making it difficult to obtain a targeted film thickness, and if the viscosity is greater than 50,000 mPa·s, coating workability may be deteriorated, and thus the resulting coating may not have uniform film thickness and may be inferior in surface smoothness and the like. A preferred lower limit is 1 mPa·s, and a preferred upper limit is 30,000 mPa·s. The viscosity described above is a value obtained by measuring with a BM type single cylindrical rotational viscometer (manufactured by Tokyo Keiki).

### 2. Coating

The “coating” of the present invention is a coating formed by coating the aqueous fluororesin coating composition of the present invention. A coating formed by using the coating composition of the present invention as a primer layer adhering to a substrate and coating a plurality of layers thereon to laminate is also included.

The “coating” of the present invention can be formed by various known coating methods, that is, a method usually used in general, such as spray coating, dip coating, spin coating, and the like. In one embodiment, in order to obtain a uniform coating by melt flowing, the coating composition is preferably heated to a melting point of the fluororesin or greater.

### 3. Coated Article

A “coated article” of the present invention is an article including a coating formed by coating the aqueous fluororesin coating composition of the present invention.

Examples of the “coated article” of the present invention include articles requiring non-tackiness, water and oil repellency and includes cookware such as frying pans and rice cookers; heat resistant releasable trays for factory lines (for a bread baking process and the like); OA equipment-related articles such as fixing roll/belts, and inkjet nozzles; industrial facility-related articles such as piping; and preferably cookware also requiring high water vapor resistance and corrosion resistance.

### EXAMPLES

### Preparation of Aqueous Fluororesin Coating Composition

For the present examples and comparative examples, the following reagents were used.

### Water-Soluble Polyamideimide (PAI) Resin

Water-soluble PAI (1): HPC-1000-28 (A solution with a PAI concentration of about 28 mass %, water from 25 to 35 mass %, and NMP from 27 to 37 mass %) manufactured by Hitachi Chemical Co., Ltd.

Water-soluble PAI (2): HPC-2100D-28 (A solution with a PAI concentration of about 28 mass %, water from 22 to 32 mass %, and N-formylmorpholine from 30 to 40 mass %) manufactured by Hitachi Chemical Co., Ltd.

### Polyetherimide (PEI) Resin

PEI powder: Ultem 1000F3SP-1000 manufactured by SABIC

### Other Binder Resins

Polyphenylsulfone (PPSU) resin powder: RADEL R-5800 manufactured by Solvay

Polyphenylenesulfide (PPS) resin powder: PQ-208 manufactured by DIC

Polyethersulfone (PES) resin powder: VERADEL (Registered Trademark) 3600RP manufactured by Solvay

### Fluororesin

PFA aqueous dispersion liquid: TEFLON (Registered Trademark) PFA334-JR (a PFA concentration of 60 mass %) manufactured by DuPont-Mitsui Fluorochemicals Company, Ltd.

PTFE aqueous dispersion liquid (1): TEFLON (Registered Trademark) PTFE34-JR (a PTFE concentration of 58 mass %) manufactured by DuPont-Mitsui Fluorochemicals Company, Ltd.

PTFE aqueous dispersion liquid (2): TEFLON (Registered Trademark) PTFE31-JR (a PTFE concentration of 60 mass %) manufactured by DuPont-Mitsui Fluorochemicals Company, Ltd.

### Filler (Pigment)

Carbon black aqueous dispersion liquid: Dispersion liquid dispersing a carbon black in pure water (a carbon black concentration of 26.9 mass %, a carbon black particle diameter (Dmax) of 13 μm)

### Example 1

To a 2-L stainless beaker, 319 mL of pure water was added, and 30 g of a surfactant aqueous solution (LEOCOL TDN90-80, an 80% nonionic surfactant aqueous solution, manufactured by Lion Corporation) was added while stirring at 140 rpm using a stirrer (Manufactured by YAMATO SCIENTIFIC CO. LTD.). In addition, 39 g of the carbon black aqueous dispersion liquid was added, the beaker contents stirred for 10 minutes, and then 57 g of the PEI powder was added thereto and the beaker contents stirred for 30 minutes. While stirring, 138 g of the PFA aqueous dispersion liquid was added, and additionally 248 g of the PTFE aqueous dispersion liquid (1) was added and the beaker contents stirred for 10 minutes, and then 169 g of the water-soluble PAI (2) was added and the beaker contents stirred for another 60 minutes to obtain an aqueous fluororesin coating composition.

### Example 2

An aqueous fluororesin coating composition was prepared in a similar manner as in Example 1, except that the addition amount of the carbon black aqueous dispersion liquid used was increased to 52 g.

### Example 3

An aqueous fluororesin coating composition was prepared in a similar manner as in Example 1, except that 10 g of N-formylmorpholine was added to the first pure water in Example 1.

### Examples 4 to 17

An amount of each component was adjusted so as to give a coating composition (a composition ratio in the resin solid content (mass %)) described in Table 1 below, to obtain fluororesin coating compositions in accordance with a similar procedure as in Example 1.

### Comparative Example 1

To a 2-L stainless beaker, 306 mL of pure water was added, and while stirring at 140 rpm using a stirrer (Manufactured by YAMATO SCIENTIFIC CO. LTD.), 12 g of an aqueous organic solvent N-formylmorpholine was added, and additionally 7 g of a surfactant (SURFINOL 440 manufactured by Air Products and Chemicals, Inc.) was added. In addition, 32 g of the carbon black aqueous dispersion liquid was added, the beaker content was stirred for 10 minutes, and then while keeping stirring, 367 g of the PFA aqueous dispersion liquid was added and the beaker content was stirred for 10 minutes. And then, 276 g of the water-soluble PAI (2) was added and the beaker content stirred for 60 minutes to obtain an aqueous fluororesin coating composition.

### Comparative Examples 2 to 5

An amount of each component was adjusted so as to give a coating composition (a composition ratio in the resin solid content (mass %)) described in Table 1 below, to obtain fluororesin coating compositions in accordance with a similar procedure as in Comparative Example 1.

### Comparative Example 6

A fluororesin coating composition was obtained in a similar manner as in Example 1, except that the PEI powder in Example 1 was replaced with the PPSU powder.

### Comparative Example 7

A fluororesin coating composition was obtained in a similar manner as in Comparative Example 6, except that the PPSU powder was increased to 48 g.

### Comparative Examples 8 and 9

A fluororesin coating composition was obtained in a similar manner as in Comparative Examples 6 and 7, except that the PPSU powder was replaced with the PPS powder.

### Comparative Example 10

A fluororesin coating composition was obtained in a similar manner as in Comparative Examples 6, except that the PPSU powder was replaced with the PES powder.

### Comparative Example 11

A fluororesin coating composition was obtained in a similar manner as in Comparative Example 10, except that the PES powder was increased to 48 g, and the PTFE aqueous dispersion liquid (1) was replaced with the PTFE aqueous dispersion liquid (2) so as to give the same weight of the PTFE resin.

Composition ratios (mass %) in resin solid content of coating compositions of the examples and the comparative examples are shown in Table 1 below.

Note that a content of the carbon black contained in the aqueous fluororesin coating composition, per 100 parts of the resin solid content, is about 3 parts except Example 2, and about 4 parts in Example 2.

TABLE 1

| | Binder resin [mass %] | | | | | | | | | | | |
|---|---|---|---|---|---|---|---|---|---|---|---|---|
| Example/ | Water-soluble PAI | | | | | | | Fluororesin [mass %] | | | | |
| Comparative | HPC- | HPC- | | Other | | | | PFA | PTFE | PTFE | | |
| Example | 1000-28 | 2100D | PEI | PPSU | PPS | PES | Total | 334-JR | 34-JR | 31-JR | Total | |
| Example 1 | | 14.5 | 17.5 | 0 | 0 | 0 | 32.0 | 25.3 | 42.7 | | 68.0 | |
| Example 2 | | 14.5 | 17.5 | 0 | 0 | 0 | 32.0 | 25.3 | 42.7 | | 68.0 | Pigment was |
| | | | | | | | | | | | | increased |
| Example 3 | | 14.5 | 17.5 | 0 | 0 | 0 | 32.0 | 25.3 | 42.7 | | 68.0 | Solvent was |
| | | | | | | | | | | | | increased |
| Example 4 | 9.4 | | 16.6 | 0 | 0 | 0 | 26.0 | 74.0 | | | 74.0 | |
| Example 5 | 9.4 | | 16.6 | 0 | 0 | 0 | 26.0 | 26.6 | | 47.4 | 74.0 | |
| Example 6 | | 9.4 | 16.6 | 0 | 0 | 0 | 26.0 | 26.6 | 47.4 | | 74.0 | |
| Example 7 | | 9.4 | 16.6 | 0 | 0 | 0 | 26.0 | 26.6 | | 47.4 | 74.0 | |
| Example 8 | | 9.4 | 16.6 | 0 | 0 | 0 | 26.0 | | | 74.0 | 74.0 | |
| Example 9 | | 6.8 | 8.2 | 0 | 0 | 0 | 15.0 | 31.6 | 53.4 | | 85.0 | |
| Example 10 | | 18.1 | 21.9 | 0 | 0 | 0 | 40.0 | 22.3 | 37.7 | | 60.0 | |
| Example 11 | | 18 | 42 | 0 | 0 | 0 | 60.0 | 14.9 | 25.1 | | 40.0 | |
| Example 12 | | 16.5 | 38.5 | 0 | 0 | 0 | 55.0 | 16.7 | 28.3 | | 45.0 | |
| Example 13 | | 5 | 14 | 0 | 0 | 0 | 20.0 | 29.8 | 50.2 | | 80.0 | |
| Example 14 | | 4.5 | 10.5 | 0 | 0 | 0 | 15.0 | 31.6 | 53.4 | | 85.0 | |
| Example 15 | | 27 | 33 | 0 | 0 | 0 | 60.0 | 14.9 | 25.1 | | 40.0 | |
| Example 16 | | 24.8 | 30.3 | 0 | 0 | 0 | 55.0 | 16.7 | 28.3 | | 45.0 | |
| Example 17 | | 9 | 11 | 0 | 0 | 0 | 20.0 | 29.8 | 50.2 | | 80.0 | |
| Comparative | | 26.0 | 0 | 0 | 0 | 0 | 26.0 | 74.0 | | | 74.0 | |
| Example 1 | | | | | | | | | | | | |
| Comparative | 26.0 | | 0 | 0 | 0 | 0 | 26.0 | 74.0 | | | 74.0 | |
| Example 2 | | | | | | | | | | | | |
| Comparative | 26.0 | | 0 | 0 | 0 | 0 | 26.0 | 26.6 | | 47.4 | 74.0 | |
| Example 3 | | | | | | | | | | | | |
| Comparative | | 26.0 | 0 | 0 | 0 | 0 | 26.0 | | 74.0 | | 74.0 | |
| Example 4 | | | | | | | | | | | | |
| Comparative | | 26.0 | 0 | 0 | 0 | 0 | 26.0 | | | 74.0 | 74.0 | |
| Example 5 | | | | | | | | | | | | |
| Comparative | | 14.5 | 0 | 17.5 | 0 | 0 | 32.0 | | 42.7 | | 68.0 | |
| Example 6 | | | | | | | | | | | | |
| Comparative | | 9.7 | 0 | 22.3 | 0 | 0 | 32.0 | 25.3 | 42.7 | | 68.0 | |
| Example 7 | | | | | | | | | | | | |
| Comparative | | 14.5 | 0 | 0 | 17.5 | 0 | 32.0 | 25.3 | 42.7 | | 68.0 | |
| Example 8 | | | | | | | | | | | | |
| Comparative | | 9.7 | 0 | 0 | 22.3 | 0 | 32.0 | 25.3 | 42.7 | | 68.0 | |
| Example 9 | | | | | | | | | | | | |
| Comparative | | 9.7 | 0 | 0 | 0 | 22.3 | 32.0 | 25.3 | 42.7 | | 68.0 | |
| Example 10 | | | | | | | | | | | | |
| Comparative | | 9.7 | 0 | 0 | 0 | 22.3 | 32.0 | 25.3 | | 42.7 | 68.0 | |
| Example 11 | | | | | | | | | | | | |

### Performance Evaluation

Coatings for use in performance evaluation below were prepared in accordance with the following procedure.

### Preparation of Test Piece for Water Vapor Resistance

### Evaluation and Corrosion Resistance Evaluation

An aluminum (A1050) with a size of 170 mm×170 mm was used as a substrate and subjected to a shot blasting with #60 alumina. Thereafter, the fluororesin coating composition of each example and each comparative example was spray coated (in an amount of the coating composition from 1.4 to 1.6 g) using a spray gun for liquid (W-101-101G, manufactured by ANEST IWATA Corporation) and dried at 170° C. for 20 minutes to form a primer layer.

Next, a PFA powder coating (TEFLON (Registered Trademark) Coating MJ-102 manufactured by DuPont-Mitsui Fluorochemicals Company, Ltd.) was electrostatically powder coated (a coating weight from 2.8 to 3.0 g) onto the primer layer using a spray gun for powder coating (GX355HW manufactured by PARKER IONICS) and sintered at 390° C. (substrate temperature) for 30 minutes to form a top coat layer and to obtain a fluororesin laminate. The resulting fluororesin laminate was used as a test piece.

### Water Vapor Resistance Evaluation

After the test piece was allowed to stand in a water vapor of 0.8 megapascals at 170° C. for 100 hours, it was left to stand until it was cooled to ordinary temperature, and then the back side of the test piece (the uncoated surface) was heated to 190° C. with a direct flame of a gas range. After heating, the test piece was rapidly cooled by immersion in water, and then generation status of blisters (rash-like swellings with a diameter less than 2 mm) and swellings (swellings with a diameter not less than 2 mm) on the coating surface were observed. With this as one cycle, the evaluation was performed three times (after 100, 200, and 300 hours).

The results are shown in a table below. In addition to the number of blisters, a test piece where one or more swellings were generated was described as “swelling”, a test piece where countless blisters or swellings were generated over the entire surface of the coating was described as “NG”, and a test piece with no change in the coating surface was described as “OK” in the table.

TABLE 2

| | Water vapor resistance evaluation | | |
|---|---|---|---|
| Example/Comparative | after 100 | after 200 | after 300 |
| Example | hours | hours | hours |
| Example 1 | OK | OK | OK |
| Example 2 | OK | OK | OK |
| Example 3 | OK | OK | OK |
| Example 4 | OK | OK | 2 Blisters |
| Example 5 | OK | OK | 3 Blisters |
| Example 6 | OK | OK | OK |
| Example 7 | OK | OK | OK |
| Example 8 | OK | OK | OK |
| Example 9 | OK | OK | OK |
| Example 10 | OK | OK | OK |
| Example 11 | OK | OK | OK |
| Example 12 | OK | OK | OK |
| Example 13 | OK | OK | OK |
| Example 14 | OK | OK | OK |
| Example 15 | OK | OK | OK |
| Example 16 | OK | OK | OK |
| Example 17 | OK | OK | OK |
| Comparative Example 1 | Swelling | NG | NG |
| Comparative Example 2 | NG | NG | NG |
| Comparative Example 3 | NG | NG | NG |
| Comparative Example 4 | Swelling | NG | NG |
| Comparative Example 5 | OK | Swelling | NG |
| Comparative Example 6 | OK | OK | Swelling |
| Comparative Example 7 | OK | OK | Swelling |
| Comparative Example 8 | OK | OK | 19 Blisters |
| Comparative Example 9 | OK | OK | 9 Blisters |
| Comparative Example 10 | OK | Swelling | NG |
| Comparative Example 11 | OK | Swelling | NG |

### Corrosion Resistance Evaluation

After the test piece was allowed to stand in a water vapor of 0.8 megapascals at 170° C. for 50 hours, it was slowly cooled to ordinary temperature. Thereafter, the test piece was immersed in a solution of 20 g of “Oden no Moto” (Manufactured by S&B Foods Inc.) dissolved in 1 L of water, kept warm at 90 to 100° C., and generation status of blisters (rash-like swellings with a diameter less than 2 mm) and swellings (swellings with a diameter not less than 2 mm) on the coating surface was observed every week until 4 weeks.

The results are shown in a table below. In addition to the number of blisters, a test piece where countless blisters were generated and detachments of parts of the coating was observed was described as “NG” in the table.

TABLE 3

| Example/Comparative | Corrosion resistance [Number of blisters] | | | |
|---|---|---|---|---|
| Example | 1 week | 2 weeks | 3 weeks | 4 weeks |
| Example 1 | 0 | 0 | 0 | 0 |
| Example 2 | 0 | 0 | 0 | 0 |
| Example 3 | 0 | 0 | 0 | 0 |
| Example 4 | 0 | 0 | 2 | 3 |
| Example 5 | 0 | 0 | 4 | 4 |
| Example 6 | 0 | 0 | 0 | 3 |
| Example 7 | 0 | 0 | 0 | 1 |
| Example 8 | 0 | 0 | 3 | 3 |
| Example 9 | 0 | 0 | 9 | 12 |
| Example 10 | 0 | 0 | 2 | 51 |
| Example 11 | 0 | 0 | 8 | 9 |
| Example 12 | 0 | 0 | 1 | 2 |
| Example 13 | 0 | 0 | 0 | 2 |
| Example 14 | 0 | 0 | 9 | 9 |
| Example 15 | 0 | 0 | 8 | 9 |
| Example 16 | 0 | 0 | 2 | 2 |
| Example 17 | 0 | 0 | 2 | 2 |
| Comparative Example 1 | 0 | 10 | 21 | 30 |
| Comparative Example 2 | NG | NG | NG | NG |
| Comparative Example 3 | NG | NG | NG | NG |
| Comparative Example 4 | 0 | 30 | 45 | 100 |
| Comparative Example 5 | 3 | 14 | 20 | 50 |
| Comparative Example 6 | 0 | 12 | 17 | 22 |
| Comparative Example 7 | 0 | 14 | 18 | 20 |
| Comparative Example 8 | 0 | 7 | 8 | 23 |
| Comparative Example 9 | 0 | 1 | 10 | 20 |
| Comparative Example 10 | 0 | 12 | 17 | 22 |
| Comparative Example 11 | 0 | 14 | 18 | 20 |

In addition, a coating for use in performance evaluation below was prepared according to the following procedure.

### Preparation of Test Piece for Adhesion Evaluation

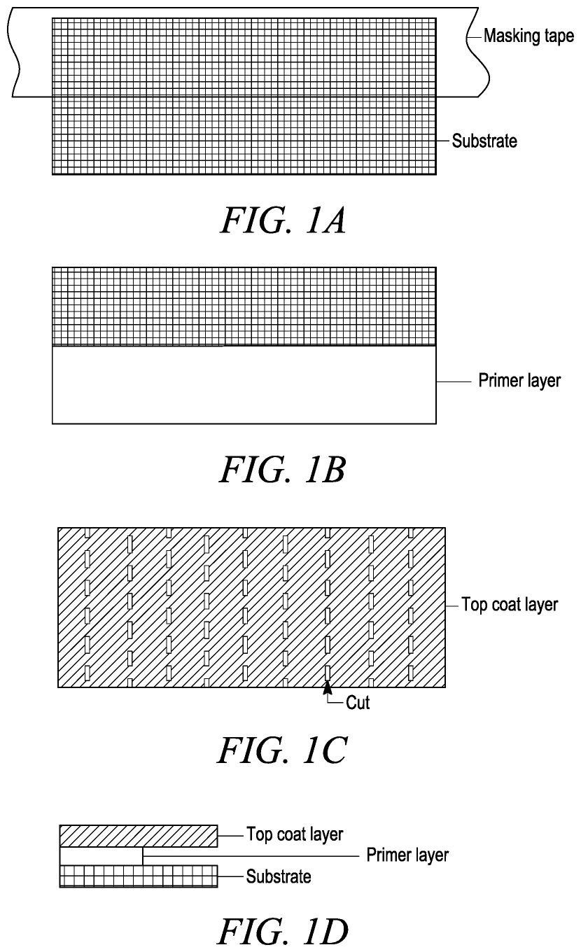

A test piece was prepared in accordance with a procedure illustrated in FIG. 1.

First, a rectangle aluminum piece (a product conforming to JIS A1050, a thickness of 1 mm) of 50 mm (short side)×100 mm (long side) was used as a substrate, and one side was masked with a masking tape about 25 mm along the long side of the substrate (FIG. 1A). After the masking, the substrate was subjected to a shot blasting with #60 alumina to make a surface roughness (Ra) of from 1 to 5 μm, followed by wiping off with isopropyl alcohol, and then the fluororesin coating composition of each example and comparative example was spray coated (the coating composition from 0.25 to 0.30 g) using a spray gun (W-101-101G, manufactured by ANEST IWATA Corporation) and dried at 170° C. for 20 minutes to form a primer layer (fluororesin coating composition layer). Next, the masking tape was peeled off, a PFA powder coating (TEFLON (Registered Trademark) Coating MJ-102 manufactured by DuPont-Mitsui Fluorochemicals Company, Ltd.) was electrostatically powder coated (a coating weight from 0.4 to 0.6 g) onto the entire surface of the substrate wherein the primer layer had been formed except for the masked part, using a powder spray gun (GX355HW manufactured by PARKER IONICS), and sintered at 390° C. (substrate temperature) for 30 minutes to form a top coat layer (PFA layer). Cuts were made with a interval of 10 mm in the short side direction with a cutter knife (FIG. 1C), the masked part was peeled off from the masked part (a top coat single layer part without the primer layer) to the laminated part with the primer layer (fluororesin coating composition layer), and the masked part peeled off was protected with a masking tape. Because the masked part has no primer layer, the top coat layer is not adhered to the substrate as can be seen from a cross section illustrated in FIG. 1D. This was used as a test piece for adhesion evaluation.

Adhesion Evaluation after Water Vapor Resistance Evaluation Test

After the test piece for the adhesion evaluation described above was allowed to stand in a water vapor of 0.8 megapascals at 170° C. for 100 hours, it was left to stand until it was cooled to ordinary temperature, and adhesion strength (peel strength) was measured. This was repeated to perform the measurement every 100 hours until 300 hours, three times in total. The measurement was performed in accordance with the following method.

### Method for Measuring Adhesion Strength

Using a Tensilon universal testing machine (manufactured by A&D Company, Limited), in accordance with the method for measuring the peel strength of an adhesive defined in JIS K 6854 (90-degree peel test method), the part protected with a masking tape was inserted to the chuck of the testing machine and pulled at a speed of 50 mm/minute to measure adhesion strength (peel strength). The unit is N (Newton)(gf(gram-force)).

The results are shown in a table below.

TABLE 4

| | | | Adhesion evaluation after water vapor | | | | | |
|---|---|---|---|---|---|---|---|---|
| Example/ | Initial adhesion to | | resistance evaluation test (N)((gf)) | | | | | |
| Comparative Example | substrate (N)((gf)) | | After 100 hours | | After 200 hours | | After 300 hours | |
| Example 1 | 16 | (1600) | 11 | (1100) | 10 | (1000) | 9 | (900) |
| Example 2 | 18 | (1800) | 10 | (1000) | 10 | (1000) | 9 | (900) |
| Example 3 | 18 | (1800) | 11 | (1100) | 10 | (1000) | 9.3 | (950) |
| Example 4 | 8 | (800) | 7 | (700) | 5 | (500) | 4.4 | (450) |
| Example 5 | 10 | (1000) | 8 | (800) | 6.4 | (650) | 5 | (500) |
| Example 6 | 10 | (1000) | 8 | (800) | 6 | (600) | 5 | (500) |
| Example 7 | 15 | (1500) | 8.3 | (850) | 7 | (700) | 5.4 | (550) |
| Example 8 | 18 | (1800) | 9 | (900) | 8.3 | (850) | 5.4 | (550) |
| Example 9 | (1300) | | 6 | (600) | 5 | (500) | 3.4 | (350) |
| Example 10 | >20 | (>2000) | 4.4 | (450) | 3 | (300) | 2.5 | (250) |
| Example 11 | >20 | (>2000) | 6 | (600) | 5.4 | (550) | 5 | (500) |
| Example 12 | >20 | (>2000) | 8.3 | (850) | 6.4 | (650) | 6 | (600) |
| Example 13 | >20 | (>2000) | 8.3 | (850) | 7.4 | (750) | 7 | (700) |
| Example 14 | 10 | (1000) | 5.4 | (550) | 2 | (200) | 2 | (200) |
| Example 15 | >20 | (>2000) | 8.3 | (850) | 6.4 | (650) | 6 | (600) |
| Example 16 | >20 | (>2000) | 8.3 | (850) | 7.4 | (750) | 7 | (700) |
| Example 17 | 17 | (1700) | 8.3 | (850) | 7.4 | (750) | 7 | (700) |
| Comparative Example 1 | >20 | (>2000) | 5 | (500) | 4 | (400) | 2 | (200) |
| Comparative Example 2 | >20 | (>2000) | 0.6 | (60) | 0 | (0) | 0 | (0) |
| Comparative Example 3 | >20 | (>2000) | 0.7 | (70) | 0 | (0) | 0 | (0) |
| Comparative Example 4 | >20 | (>2000) | 5.4 | (550) | 4 | (400) | 2 | (200) |
| Comparative Example 5 | >20 | (>2000) | 6 | (600) | 5 | (500) | 2 | (200) |
| Comparative Example 6 | 19 | (1900) | 5 | (500) | 4.4 | (450) | 2.5 | (250) |
| Comparative Example 7 | 19 | (1900) | 5 | (500) | 3.4 | (350) | 2 | (200) |
| Comparative Example 8 | 19 | (1900) | 5 | (500) | 3.4 | (350) | 3 | (300) |
| Comparative Example 9 | 18 | (1800) | 6 | (600) | 3.4 | (350) | 2 | (200) |
| Comparative Example 10 | 15 | (1500) | 6 | (600) | 4 | (400) | 2.5 | (250) |
| Comparative Example 11 | 19 | (1900) | 5 | (500) | 3.4 | (350) | 2 | (200) |

1. An aqueous fluororesin coating composition comprising a water-soluble polyamideimide resin, a polyetherimide, and a fluororesin.

2. The aqueous fluororesin coating composition according to claim 1, wherein the amount of fluororesin is from 35 to 90 mass % with respect to a total mass of the water-soluble polyamideimide resin, the polyetherimide, and the fluororesin.

3. The aqueous fluororesin coating composition according to claim 1, wherein the fluororesin is a melt-flowable perfluororesin.

4. The aqueous fluororesin coating composition according to claim 1, wherein the fluororesin is a tetrafluoroethylene-perfluoro(alkylvinylether) copolymer.

5. A coating formed by coating the aqueous fluororesin coating composition described in claim 1.

6. A coated article comprising the coating described in claim 5.

7. The coated article according to claim 6, wherein the coated article is cookware.
